(19) United States
(12) Patent Application Publication
(10) Pub. No.: US 2004/0239694 A1
(43) Pub. Date: Dec. 2, 2004

(54) Image display and its drive method

(76) Inventors: Minoru Takeda, Takatsuki-shi (JP); Shinji Masuda, Settsu-shi (JP)

Correspondence Address: SNELL & WILMER LLP, 1920 MAIN STREET, SUITE 1200, IRVINE, CA, 92614-7230, US

(21) Appl. No.: 10/481,311

(22) PCT Filed: Jun. 19, 2002
(86) PCT No.: PCT/JP02/06090

(30) Foreign Application Priority Data
Jun. 20, 2001 (JP) 2001-186142

(51) Int. Cl. G09G 5/10

(52) U.S. Cl. 345/690

(57) ABSTRACT

The present invention reduces degradation in image quality caused by a write defect. This is achieved in the following manner. When driving an image display device in which a plurality of cells are arranged to display an image in gray level, by, for each of the plurality of cells, performing a writing operation in sub-fields selected from N sub-fields which form one field and each have a luminance weight, based on an input image signal for the cell, if the writing operation and light emission are performed in the cell in any sub-field in a sub-field group which is constituted by M consecutive sub-fields in the N sub-fields, where 2□M□N, the light emission is sustained in the cell throughout all succeeding sub-fields in the sub-field group, and the number of sub-fields in the sub-field group in which the writing operation is to be performed in the cell L is determined based on at least one of the input image signal for the cell for the field and an input image signal for the cell for an immediately previous field, and the writing operation is performed in each of the selected sub-fields.

### TECHNICAL FIELD

The present invention relates to an image display device such as a plasma display device and a driving method for the same.

### BACKGROUND ART

In recent years, plasma display panels (hereinafter referred to as PDPs) have been attracting attention in the field of display devices used for computers, televisions and the like, as they enable a large, slim and lightweight display device to be realized.

There are direct current (DC) type PDPs and alternating current (AC) type PDPs, and AC types form the main stream at the present time.

In typical AC surface discharge PDPs, a pair of a front substrate and a back substrate are placed so as to oppose each other. A scan electrode group and a sustain electrode group are arranged in parallel stripes on the opposing surface of the front substrate. The scan and sustain electrode groups are covered with a dielectric layer. A data electrode group is disposed in stripes on the opposing surface of the back substrate so as to cross over the scan electrode group at right angles. A gap between the front substrate and the back substrate is divided into spaces by barrier ribs. A discharge gas is enclosed into the spaces. As a result, a plurality of discharge cells are formed in a matrix configuration in areas where the scan electrode group intersects with the data electrode group.

The discharge cells are fundamentally only capable of two display states, ON and OFF. Accordingly, PDPs are driven using a field timesharing gradation display method, in which one frame (field) is divided into a plurality of sub-fields, and ON and OFF states in each sub-field are combined to express a gray scale.

PDPs are driven in such a manner that each discharge cell is lit or unlit in sub-fields each of which includes a series of a set-up period, a write period, a discharge sustain period, and an erase period. In the set-up period, a set-up pulse is applied to initialize all of the discharge cells. In the address period, while a scan pulse is sequentially applied to the scan electrode group, a write pulse is applied to electrodes selected from the data electrode group. This causes a wall charge to accumulate, to write pixel information. In the discharge sustain period, a sustain pulse having a rectangular waveform is alternately applied to the scan electrode group and the sustain electrode group. This causes a main discharge to sustain so as to perform light emission. In the erase period, wall voltages in the discharge cells is erased.

The following PDP driving method is disclosed in unexamined Japanese patent application publication No. 2000-231362. A display period of one field is divided into N sub-fields. Here, M consecutive sub-fields (2□M□N) out of the N sub-fields form a sub-field group. If pixel information is written into a given discharge cell and a sustain discharge is performed in the given discharge cell in one sub-field of the sub-field group, the sustain discharge is maintained in the given discharge cell in which the pixel information is written in the sub-field, for all of the succeeding sub-fields in the sub-field group.

According to this driving method, a set-up operation and an erase operation are not performed in the middle of the sub-field group.

In FIG. 11, for example, one field includes a sub-field group that is formed from four sub-fields SF1, SF2, SF3 and SF4 that are consecutively arranged in a time series. These sub-fields each have a luminance weight of 32. An erase operation is not performed after a discharge sustain operation is completed in each of the sub-fields SF1, SF2 and SF3. A set-up operation is performed before a writing operation is performed in the first sub-field SF1, and an erase operation is performed after the discharge sustain operation is performed in the last sub-field SF4.

To display a gray level 32 using such a sub-field group, writing and a sustain discharge are performed in the sub-field SF4. To display a gray level 64, writing is performed in the sub-field SF3, and a sustain discharge is maintained throughout the sub-fields SF3 and SF4. To display a gray level 96, writing operation is performed in the sub-field SF2, and a sustain discharge is maintained throughout the sub-fields SF2, SF3 and SF4. To display a gray level 128, writing is performed in the sub-field SF1, and a sustain discharge is maintained throughout the sub-fields SF1 to SF4.

The above driving method suppresses the occurrence of false contours, as a change in gray level causes a relatively small change in a light-emitting pattern. In addition, a writing operation is performed in only one sub-field in the sub-field group, i.e., in the first sub-field of the sub-fields for which light emission is maintained. Therefore, low power consumption and excellent contrast are achieved.

Here, pixel information is written into a cell in only one sub-field in the sub-field group, that is, in the first sub-field of the sub-fields for which light emission is maintained. However, if a write defect occurs (a wall charge does not sufficiently accumulate in the cell), the cell remains unlit throughout the sub-field group. As a result, image quality significantly drops.

In the example given in FIG. 11 described above, to display a gray level 128, pixel information needs to be written in a cell in the sub-field SF1. Here, if a write defect occurs in the sub-field SF1, the cell remains unlit during the sub-fields SF1 to SF4. As a result, a gray level “0” is reproduced instead of the gray level 128, which causes a great loss in image quality.

To solve the above problem, in a sub-field group, writing maybe performed, not only in the first sub-field of the sub-field for which light emission is maintained, but also in sub-fields succeeding the above first sub-field. This reduces a ratio of unlit cells, and therefore suppresses worsening of image quality. According to this method, however, more writing operations are performed in the sub-field group, which causes an increase in power consumption.

### DISCLOSURE OF THE INVENTION

It is an object of the present invention to suppress deterioration of image quality caused by a write defect with reducing power consumption, when driving an image display device using a method whereby if pixel information is written into a cell in a sub-field of a sub-field group then a sustain discharge is continuously performed in the cell in the succeeding sub-fields up to the last sub-field of the sub-field group.

The object can be achieved in the following manner. When driving an image display device in which a plurality of cells are arranged, to display an image in gray level, by (i) selecting, for each of the plurality of cells, one or more sub-fields in which a writing operation is to be performed, from N sub-fields which form one field and each have a luminance weight, based on an input image signal for the cell, (ii) performing the writing operation to the cell in each of the selected sub-fields, and (iii) performing light emission in the cell to which the writing operation is performed, if the writing operation and the light emission are performed in the cell in any sub-field in a sub-field group which is constituted by M consecutive sub-fields in the N sub-fields, where 2□M□N, the light emission is sustained in the cell throughout all succeeding sub-fields in the sub-field group, and when L is a number showing how many sub-fields in the sub-field group have been selected in the writing sub-field selecting step, L is determined based on at least one of the input image signal for the cell for the field and an input image signal for the cell for an immediately previous field.

The number of writing sub-fields in the sub-field group L is determined according to the following rule. The more difficult the cell is expected to be to illuminate, judging from at least one of the input image signal for the cell for the field and the input image signal for the cell for the immediately previous field, the larger L is set.

This is achieved in the following manner. The longer a time period from a start of the sub-field group to a sub-field in which the writing operation is to be first performed in the sub-field group is, the larger L is set.

Here, when one or more sub-fields precede the sub-field group in the field, the smaller a degree of the light emission in the cell (a number of times the cell is illuminated) in the sub-fields preceding the sub-field group is, the larger L is set.

Here, the smaller a degree of the light emission in the cell (a number of times the cell is illuminated) in the immediately previous field is, the larger L is set.

According to the present invention described above, the number of writing sub-fields in the sub-field group L is determined based on the ON/OFF states in the cell in the sub-fields preceding the sub-field group. This reduces the total number of writing sub-fields in one field as well as the ratio of unlit cells, when compared with the case in which the number of writing sub-fields in the sub-field group L is uniformly determined.

Here, when one or more sub-fields precede the sub-field group in the field, if the writing operation is performed in the cell only in the sub-field group to reproduce a gray level shown by the input image signal for the cell for the field, the gray level is converted into a gray level for which the writing operation is to be performed also in at least one of the sub-fields preceding the sub-field group, before writing sub-fields are selected. In this way, a write defect is suppressed with reducing the total number of writing sub-fields in one field.

### BRIEF DESCRIPTION OF THE DRAWINGS

FIG. 1 shows a construction of a PDP device relating to a first embodiment.

FIGS. 2A, 2B and 2C show a conversion table provided for a sub-field conversion unit 700 (shown in FIG. 1).

FIG. 3 shows a timetable for driving a PDP 100 (shown in FIG. 1).

FIG. 4 shows a driving voltage applied to each type of electrode when driving the PDP 100.

FIG. 5 schematically shows an internal structure of a sub-field memory 701 (shown in FIG. 1).

FIG. 6 is a flow chart describing an operation of a data detection unit 500 (shown in FIG. 1) relating to a modification of the first embodiment.

FIG. 7 shows a structure of part of a PDP device relating to a second embodiment.

FIG. 8 is a flow chart showing one example of an operation of the sub-field conversion unit 700 in the first embodiment.

FIG. 9 shows an example calculation table used by the sub-field conversion unit 700 for calculating the number of writing sub-fields L in the second embodiment.

FIGS. 10A and 10B each show, as an example, a conversion table used by the sub-field conversion unit 700 for producing writing SF indication data.

FIG. 11 shows one example of a sub-field group, which is composed of four sub-fields.

### BEST MODE FOR CARRYING OUT THE INVENTION

[First Embodiment]

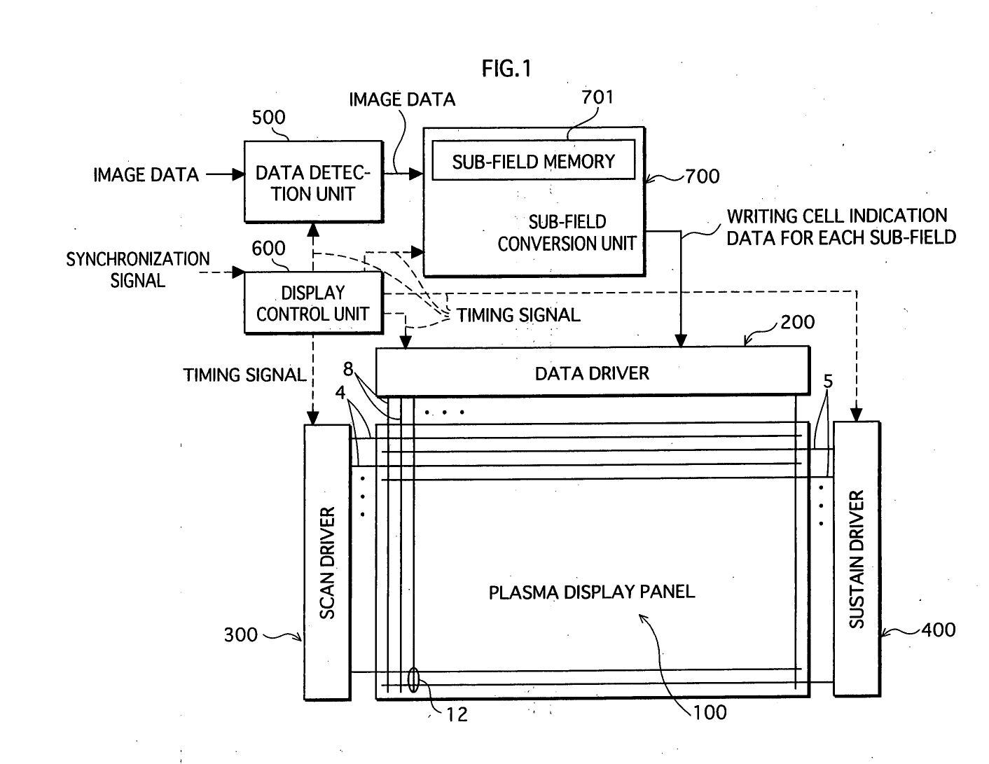

FIG. 1 shows a construction of a PDP device relating to a first embodiment.

The PDP device shown in FIG. 1 includes a PDP 100, a data driver 200, a scan driver 300, a sustain driver 400 and a sub-field conversion unit 700.

The PDP 100 includes a pair of a front substrate and a back substrate. A plurality of scan electrodes 4 and a plurality of sustain electrodes 5 extending in the horizontal direction of the panel screen are arranged on the front substrate. A plurality of data electrodes 8 extending in the vertical direction of the panel screen are arranged on the back substrate.

The scan electrodes 4, the sustain electrodes 5 and the data electrodes 8 are arranged so as to form a matrix configuration.

Discharge cells 12 are formed at points where the scan electrodes 4 and the sustain electrodes 5 intersect with the data electrodes 8. A discharge gas is enclosed into each of the discharge cells 12. Hence the discharge cells 12 form pixels on the panel screen. In general, three discharge cells (red, green and blue) adjacent in the horizontal direction of the panel screen form one pixel.

The discharge cells of a PDP are fundamentally only capable of two display states, ON and OFF. Accordingly, PDPs are driven using a field timesharing gradation display method to express a gray scale.

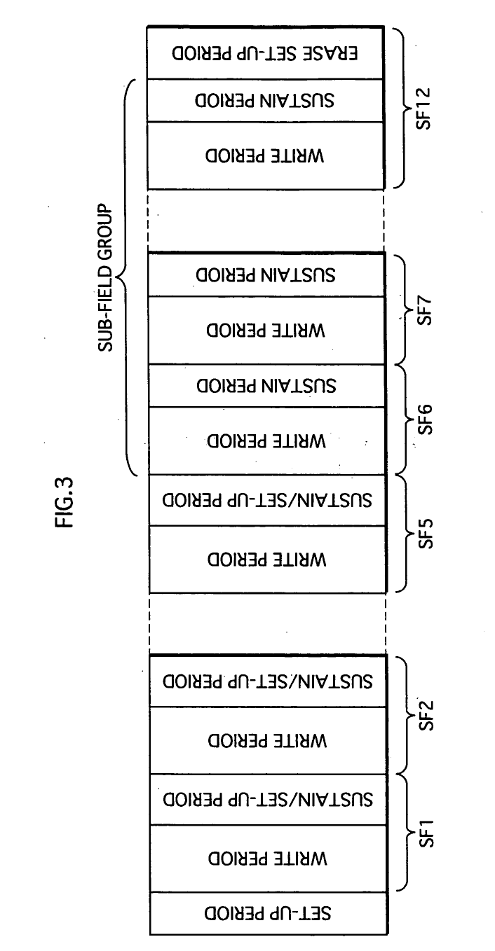

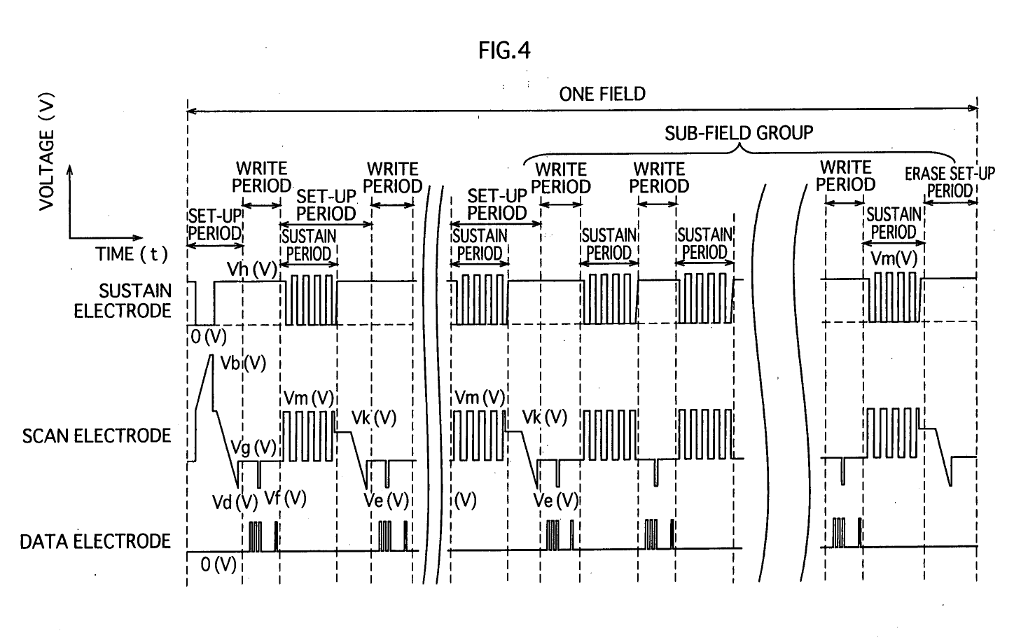

FIG. 3 shows a time table for driving the PDP 100, and FIG. 4 shows driving voltages applied to the scan electrodes 4, the sustain electrodes 5 and the data electrodes 8 when driving the PDP 100.

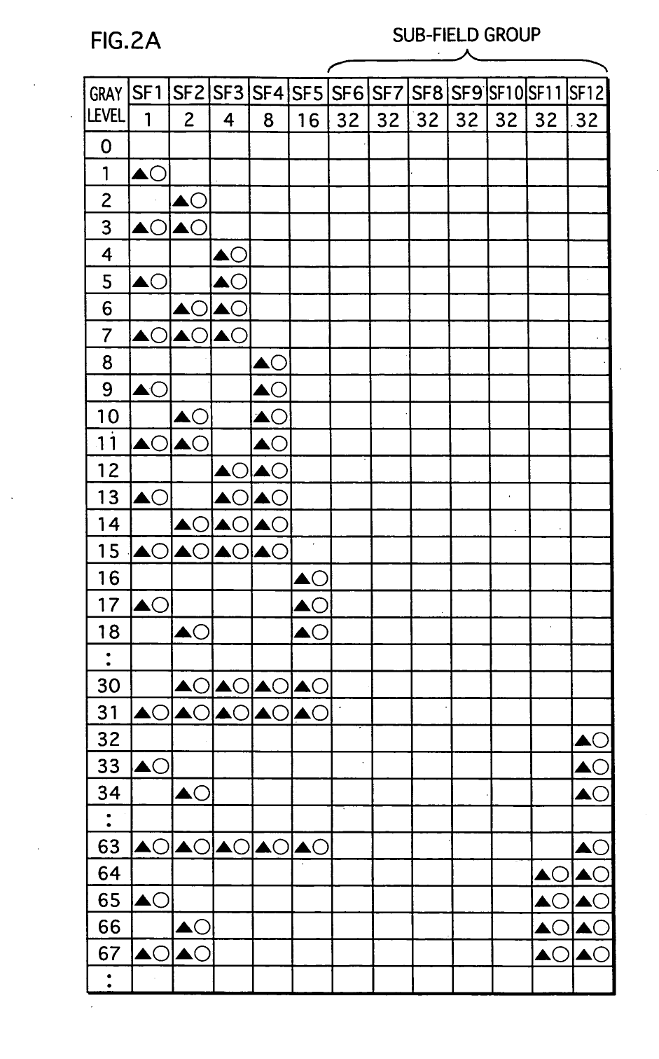

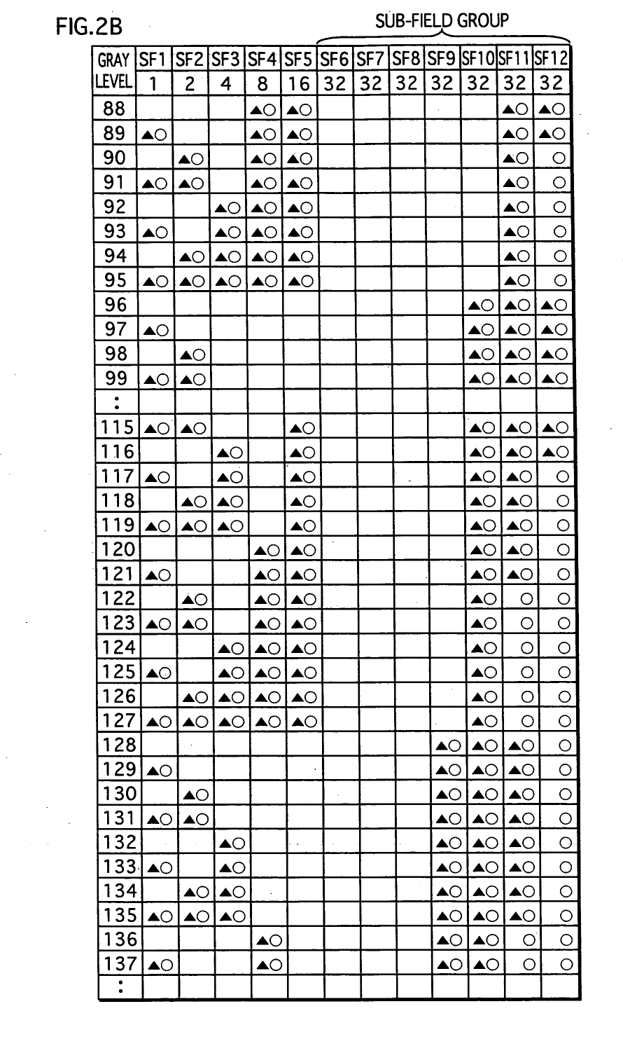

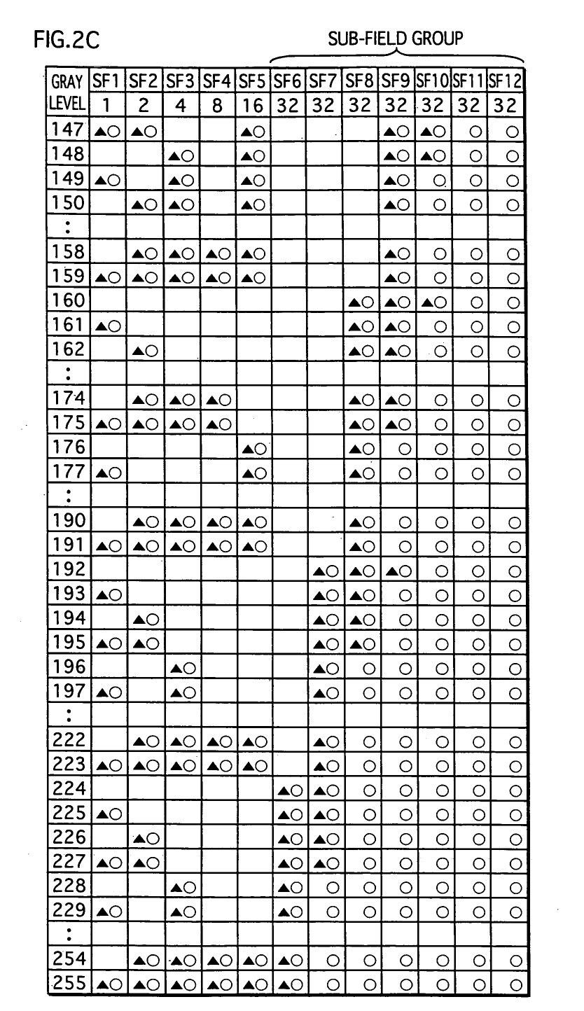

In FIG. 3, one field is composed of twelve sub-fields (SF1 to SF12). Each of the sub-fields includes a write period and a discharge sustain period. The lengths of the discharge sustain periods (luminance weights) are set at 1, 2, 4, 8, 16 in the sub-fields SF1 to SF5 and 32 in each of the sub-fields SF6 to SF12, as shown in FIGS. 2A, 2B and 2C.

Here, light emission is selectively performed in the sub-fields SF1 to SF5 to express gray levels 1 to 31. Also, light emission is selectively performed in the sub-fields SF6 to SF12 to express gray levels 32, 64, 128 and 228. Accordingly, ON and OFF states in the sub-fields SF1 to SF12 are combined to express 256 gray levels.

As shown in FIG. 3, a set-up period is provided immediately before each of the sub-fields SF1 to SF6. In the set-up period, a voltage (e.g. V_{b}, V_{d}, Vₖ and Vₕ illustrated in FIG. 4) is applied to the scan electrodes and the sustain electrodes so as to cause a weak discharge in the discharge cells. This erases charges left in discharge cells which were lit in an immediately preceding sub-field, and therefore makes it easy to perform a writing operation in the discharge cells. In a write period, a voltage Vₑ is selectively applied between the scan electrodes and the data electrodes, to perform a writing operation. In a discharge sustain period, a voltage (Vₘ in FIG. 4) is applied between the scan electrodes and the sustain electrodes in the discharge sustain period. This causes a sustain discharge to be performed in discharge cells to which a writing operation has been performed in the write period, and those discharge cells emit light. A sustain discharge is not performed in discharge cells to which the writing operation has not been performed, and those cells therefore do not emit light.

On the other hand, the set-up period is not provided immediately before the write period in each of the sub-fields SF7 to SF12. Accordingly, when a sustain discharge is performed in one of the sub-fields SF6 to SF11, the sustain discharge is continued in all of the sub-fields succeeding that sub-field.

More specifically, if a writing operation is performed in a discharge cell in one sub-field in a sub-field group composed of the sub-fields SF6 to SF12, a sustain discharge (light emission) is continuously performed in that discharge cell in the following sub-fields up to the last sub-field SF12 of the sub-field group, even without performing a writing operation in the following sub-fields.

A change in a light-emitting pattern caused by a change in gray level is relatively small in the sub-field group. This suppresses the occurrence of false contours. In addition, the number of the writing operations and the number of set-up operations performed in the sub-field group are small, which contributes to low power consumption and excellent contrast.

The following part describes the functions of the units shown in FIG. 1.

Image data is input to a data detection unit 500. The image data indicates a gray level for each discharge cell in the PDP 100. For example, when each discharge cell reproduces a 256-level gray scale, a gray level for one discharge cell is expressed by eight-bit data.

The data detection unit 500 sequentially transfers image data for each discharge cell (a gray level) to the sub-field conversion unit 700. The transfer of image data is performed according to the arrangement order of the discharge cells in the PDP 100.

The sub-field conversion unit 700 produces writing SF indication data for each of the discharge cells, based on image data for each discharge cell sent from the data detection unit 500. Writing SF indication data indicates sub-fields, in the sub-fields SF1 to SF12, in which a writing operation should be performed to a discharge cell. The sub-field conversion unit 700 produces writing cell indication data for each of the sub-fields SF1 to SF12 based on writing SF indication data. Writing cell indication data indicates discharge cells to which a writing operation should be performed in each of the sub-fields SF1 to SF12. The sub-field conversion unit 700 sends writing cell indication data to the data driver 200.

A display control unit 600 receives a synchronization signal (e.g. a horizontal synchronization signal (Hsync) and a vertical synchronization signal (Vsync)) in synchronization with an image signal.

Based on the synchronization signal, the display control unit 600 sends, to the data detection unit 500, a timing signal that indicates a timing of transferring image data. The display control unit 600 sends, to the sub-field conversion unit 700, a timing signal that indicates a timing of writing/reading data into/from a sub-field memory 701. The display control unit 600 sends, to the data driver 200, the scan driver 300 and the sustain driver 400, a timing signal that indicates a timing of applying a pulse.

The data driver 200 is connected to the data electrodes 8, and selectively applies a write pulse to the data electrodes 8 in the write period of each sub-field to perform steady write discharge in the discharge cells 12.

The scan driver 300 is connected to the scan electrodes 4, and applies a set-up pulse, a scan pulse, a sustain pulse and an erase pulse to the scan electrodes 4 in the set-up period, the write period, the sustain period and the erase period of each sub-field so that a set-up discharge, a write discharge, a sustain discharge and an erase discharge are stably performed in the discharge cells 12.

The sustain driver 400 is connected to the sustain electrodes 5, and applies a sustain pulse and pulses for performing a writing operation and an erase operation to the sustain electrodes 5 in the sustain period, the write period and the erase period of each sub-field so as that the sustain discharge, the write discharge, and the erase discharge are stably performed in the discharge cells 12.

[Construction of Sub-Field Conversion Unit 700]

The sub-field conversion unit 700 has a conversion table that presents a correspondence between a gray level and information showing sub-fields in which the writing operation should be performed in one field.

FIGS. 2A, 2B and 2C show such a conversion table. The leftmost column shows gray levels shown by input image data. For each gray level, □ marks represent sub-fields in which a writing operation should be performed.

The sub-fields indicated by □ marks are in the ON state (lit), and the sub-fields without □ marks are in the OFF state (unlit).

When image data for a given discharge cell is input into the sub-field conversion unit 700, the sub-field conversion unit 700 produces writing SF indication data corresponding to a gray level for the given discharge cell shown by the image data, by referring to the above-mentioned conversion table. Then, the sub-field conversion unit 700 writes the writing SF indication data into the sub-field memory 701. Writing SF indication data has the number of bits (12 bits in the first embodiment) equal to the sub-fields composing one field.

In addition, the sub-field conversion unit 700 reads writing SF indication data for the sub-fields SF1 to SF12 from the sub-field memory 701 one by one, and outputs the read data as writing cell indication data to the data driver 200.

The operation of writing/reading data into/from the sub-field memory 701 is concretely described in the following part.

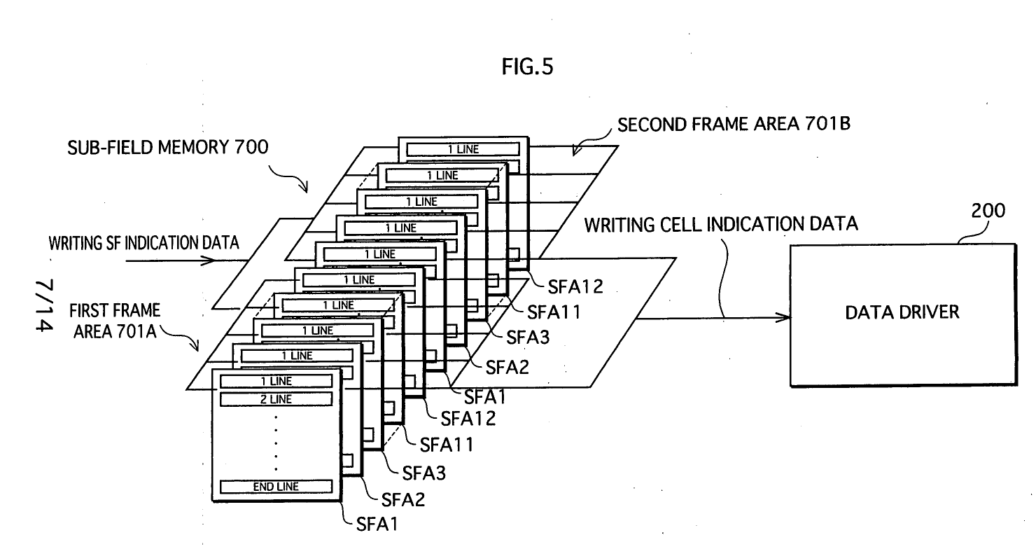

FIG. 5 schematically shows an inner structure of the sub-field memory 701.

The sub-field memory 701 is a two-port frame memory including a first frame area 701A and a second frame area 701B. The first frame area 701A stores writing SF indication data for one frame, and the second frame area 701B stores writing SF indication data for the next frame.

The first frame area 701A and the second frame area 701B each include twelve sub-field areas SFA1 to SFA12. Each of the sub-field areas SFA1 to SFA12 stores information indicating the ON/OFF state of each cell in the PDP 100. In FIG. 5, each of the sub-field areas SFA1 to SFA12 has line memory areas that correspond one-to-one with the scan lines in the PDP 100.

The sub-field conversion unit 700 alternately writes/reads data into/from the first frame area 701A and the second frame area 701B, based on the above-mentioned timing signal. In detail, while the sub-field conversion unit 700 writes writing SF indication data into one of the first frame area 701A and the second frame area 701B, the sub-field conversion unit 700, sub-field by sub-field, reads data from the other frame area.

Here, the sub-field conversion unit 700 writes 12 bit of writing SF indication data separately to corresponding one of the sub-field areas SFA1 to SFA12 in sub-field memory 701.

For example, when image data for a given discharge cell (gray level 115) is input into the sub-field conversion unit 700, the sub-field conversion unit 700 produces, with reference to the section for the gray level 115 in the conversion table shown in FIGS. 2A, 2B and 2C, 12-bit writing SF indication data “110010000111”, which indicates that the writing operation is to be performed in the sub-fields SF1, SF2, SF5, SF10, SF11 and SF12. The sub-field conversion unit 700 writes this writing SF indication data for the given discharge cell separately in corresponding one of the sub-field areas SFA1 to SFA12. Here, writing SF indication data is written in an address, in a corresponding sub-field area, corresponding to the given discharge cell.

On the other hand, the sub-field conversion unit 700 reads data from the sub-field memory 701 in the following manner. The sub-field conversion unit 700 sequentially reads data from the sub-field areas SFA1 to SFA12, and sends the read data to the data driver 200 as writing cell indication data.

More specifically, the sub-field conversion unit 700 reads writing cell indication data of the first line from the sub-field area SFA1 in the write period of the sub-field SF1, and sends the read data to the data driver 200. After this, the sub-field conversion unit 700 reads writing cell indication data of the second line from the sub-field area SFA1, and sends the read data to the data driver 200. In this way, the sub-field conversion unit 700 reads data of all of the lines from the sub-field area SFA1, to complete reading for the sub-field SF1.

After this, in the same manner, the sub-field conversion unit 700 reads, line by line, writing cell indication data from the sub-field area SFA2 in the write period of the sub-field SF2, and sends the read data to the data driver 200.

Here, the data driver 200 applies, line by line, write pulses to the data electrodes 8 in parallel according to the writing cell indication data that is input thereto.

[Characteristics and Effects of the Conversion Table Described Above]

The following part explains the characteristics of the conversion table shown in FIGS. 2A, 2B and 2C.

As shown in FIGS. 2A, 2B and 2C, the number of sub-fields in which a writing operation is to be performed (indicated by □ marks) in the sub-field group (herein after the number of writing sub-fields L) is not uniformly determined, but set based on the following two rules.

(1) If a time period from a start of a sub-field group to a sub-field in which the first light emission is performed in the sub-field group is long, the number of writing sub-fields L is set large. If the time period from the start of the sub-field group to the first light-emitting sub-field in the sub-field group is short, the number of writing sub-fields L is set small.

This characteristic of the conversion table produces the following effects.

As shown in FIG. 3, the set-up period is provided immediately before the first sub-field SF6 in the sub-field group and in the last sub-field SF12 in the sub-field group. However, the set-up period is not provided in the middle of the sub-field group. Accordingly, when the time period from the start of the sub-field group to the first light-emitting sub-field in the sub-field group is longer, a time period from the set-up period to a sub-field in which a writing operation is first performed (first writing sub-field) in the sub-field group is longer. Here, when the time period from the set-up operation to the first writing operation in the sub-field group is longer, wall charges that accumulate in the discharge cells as a result of the set-up operation are more likely to disappear, so that a write defect is more likely to occur in the first writing sub-field in the sub-field group. In conclusion, when the time period from the start of the sub-field group to the first light-emitting sub-field in the sub-field group is longer, a write defect is more likely to occur in the first writing sub-field in the sub-field group.

Here, when the time period from the start of the sub-field group to the first light-emitting sub-field in the sub-field group is longer, the number of writing sub-fields L is set larger. In this way, when a write defect is more likely to occur in the first light-emitting sub-field in the sub-field group, a writing operation is performed in more sub-fields after the first light-emitting sub-field in the sub-field group (the occurrence of a write defect is reduced).

(2) If the number of sustain pulses (the number of light emissions) is small in the sub-fields SF1 to SF5 preceding the sub-field group, the number of writing sub-fields L is set large. If the number of light emissions is large in the sub-fields SF1 to SF5, the number of writing sub-fields L is set small.

These characteristics of the conversion table produce the following effects.

If the number of light emissions in the sub-fields SF1 to SF5 that precede the sub-field group is small, or the time period from the set-up operation to the first writing operation in the sub-field group is long, a discharge firing voltage of the discharge cells is high (mentioned in detail later). Accordingly, a write defect is likely to occur in the first writing sub-field in the sub-field group.

According to the above rules (1) and (2), however, when a write defect is more likely to occur in the first light-emitting sub-field, the number of writing sub-fields L is set larger (namely, the writing operation is performed in more sub-fields following the first light-emitting sub-field in the sub-field group).

Thus, the characteristics (1) and (2) make it possible to suppress the occurrence of lighting defects in the sub-field group so as to prevent the occurrence of dark points with reducing the total number of writing sub-fields in one field, when compared with the case in which the number of writing sub-fields L is uniformly determined.

Here, power consumption of the data-driver module is proportional to the total number of writing sub-fields in one field. Accordingly, if the total number of writing sub-fields is reduced as described above, power consumption can be decreased.

[The Relation Between the Number of Light Emissions in Sub-Fields Preceding a Sub-Field Group and a Discharge Firing Voltage, and the Relation Between a Time Elapsed Since the End of a Discharge and a Discharge Firing Voltage]

When light emission is performed in a discharge cell, excited atoms and charged particles (e.g. ions or electrons of neon and xenon) are generated by a discharge in a discharge space of the discharge cell. The atoms and particles collide with each other, which increases the number of the atoms and particles. Therefore, the number of excited atoms and charged particles increases as the number of light emissions increases. Here, the increase in the number of excited atoms and charged particles makes it easy to generate a discharge (priming effects), and thereby lowers a discharge firing voltage.

The charged particles and excited atoms have time constants, and each particle or atom has a different time constant. An excited atom has, for example, a time constant of several hundred us. Accordingly, the number of excited atoms and charged particles decreases as time elapses after the last discharge.

In addition, a protective layer that is generally composed of MgO faces the discharge spaces of the discharge cells. The discharge firing voltage of the MgO protective layer drops as the temperature inside the discharge cells rises. Here, a discharge causes the temperature inside the discharge cells to rise. Therefore, the discharge firing voltage falls as the number of light emissions increases, and the decrease in discharge firing voltage makes it easier to perform a discharge.

As a result, an increase in the number of light emissions heightens priming effects, and thereby lowers the discharge firing voltage. However, priming effects decrease as time elapses from the last discharge, which raises the discharge firing voltage.

[Description of the Characteristics of the Conversion Table Taking a Specific Gray Level as an Example]

The above-described characteristics of the conversion table shown in FIGS. 2A, 2B and 2C are explained with taking several specific gray levels as an example.

Characteristic (1):

When reproducing the gray levels 97, 129, 161, 193 and 225, light emission is performed only in the sub-field SF1 in the sub-fields SF1 to SF5. Here, the first writing operation in the sub-field group is performed in the sub-field SF10 for reproducing the gray level 97, the sub-field SF9 for reproducing the gray level 129, the sub-field SF8 for reproducing the gray level 161, the sub-field SF7 for reproducing the gray level 193 and the sub-field SF6 for reproducing the gray level 225. Therefore, the time period from the set-up period to the first writing sub-field in the sub-field group is the shortest for the gray level 225, and becomes longer for each of the gray levels 193, 161, 129 and 97 in this order.

Here, the number of writing sub-fields L is three for the gray levels 97 and 129, and two for the gray levels 161, 193 and 225.

Which is to say, regarding the gray levels 97, 129, 161, 193 and 225, when the time period from the set-up period to the first writing sub-field in the sub-field group is longer, the number of writing sub-fields L is larger.

In detail, since the time period from the set-up period to the first writing sub-field in the sub-field group is relatively long for the gray levels 97 and 129, the number of writing sub-fields L is set at three for these gray levels to suppress lighting defects in the sub-field group. On the other hand, since the time period from the set-up period to the first writing sub-field in the sub-field group is relatively short for the gray levels 161, 193 and 225, the number of writing sub-fields L is set at only two. Thus, when compared with the case in which the number of writing sub-fields L is uniformly set at three for these gray levels, the total number of writing sub-fields in one field is made smaller with suppressing lighting defects in the sub-field group.

Characteristic (2):

When reproducing each of the gray levels 192 to 223, the first writing operation in the sub-field group is performed in the sub-field SF7. However, the number of light emissions in the sub-fields SF1 to SF5 is the smallest for the gray level 192, and becomes larger for each of the gray levels 193 to 223 in this order.

Here, the number of writing sub-fields L is set at three for the gray level 192, two for the gray levels 193 to 195, and one for the gray levels 196 to 223.

Which is to say, regarding the gray levels 192 to 223, when the number of light emissions in the sub-fields preceding the sub-field group is smaller, the number of writing sub-fields L is set larger.

In detail, since the number of light emissions in the sub-fields preceding the sub-field group is significantly small for the gray level 192, the number of writing sub-fields L is set at three. Since the number of light emissions is comparatively small for the gray levels 193 to 195, the number of writing sub-fields L is set at two. Since the number of light emissions is relatively large for the gray levels 196 to 223, the number of writing sub-fields L is set at as small as one. In this way, when compared with the case in which the number of writing sub-fields L is uniformly set at three, the total number of writing sub-fields in one field is reduced with suppressing lighting defects in the sub-field group.

[Selection of Sub-Fields, from a Sub-Field Group, in which a Writing Operation is to be Performed]

According to the conversion table shown in FIGS. 2A, 2B and 2C, when the number of writing sub-fields L is two or more, the second and subsequent writing operations in the sub-field group are performed in the sub-fields which immediately succeed the first writing sub-field in the sub-field group. In other words, the writing operation is successively performed in the sub-fields immediately following the first writing sub-field in the sub-field group. In this way, even if a write defect occurs in the first writing sub-field in the sub-field group, it is only the first writing sub-field which is not illuminated, as long as the second writing operation is properly performed. Thus, occurrence of a lighting defect is significantly suppressed.

To reproduce the gray level 192, for example, the first writing operation in the sub-field group is performed in the sub-field SF7, and the second and third writing operations are performed in the sub-fields SF8 and SF9 respectively. Here, even if a write defect occurs in the sub-field SF7, it is only the sub-field SF7 which is not illuminated, as long as the second writing operation is properly performed in the sub-field SF8. Note that the second and subsequent writing operations are not necessarily performed in the sub-fields that immediately succeed the first writing sub-field. The second writing operation in the sub-field group, for example, maybe performed in the second sub-field from the first writing sub-field in the sub-field group. In this case, however, if a write defect occurs in the first writing sub-field in the sub-field group, two sub-fields are not illuminated, even though the second writing operation is properly performed.

[Example Modifications of the First Embodiment]

The rules (1) and (2) described above are preferably followed when determining the number of writing sub-fields L for all of the gray levels 64 to 255, that is to say, if light emission is performed in two or more sub-fields in the sub-field group to reproduce a gray level. However, the rules may be followed for part of those gray levels.

The conversion table shown in FIGS. 2A, 2B and 2C has both of the above-mentioned characteristics (1) and (2). However, so long as the conversion table has one of the characteristics (1) and (2), lighting defects in the sub-field group are suppressed with reducing the total number of writing sub-fields in one field.

The conversion table can have the characteristic (2) only if one field includes at least one sub-field prior to a sub-field group. On the other hand, the conversion table can have the characteristic (1) even if one field includes no sub-fields prior to the sub-field group. For example, the conversion table can have the characteristic (1) even when one field includes five sub-fields which each have a luminance weight of 1, 2, 4, 8 and 16 after a sub-field group composed of seven sub-fields each having a luminance weight of 32.

A luminance weight is uniformly set at 32 for all of the sub-fields forming the sub-field group in the example conversion table shown in FIGS. 2A, 2B and 2C, but is not necessarily uniform for all of the sub-fields forming a sub-field group.

In addition, the luminance weights of the sub-fields SF1 to SF5 preceding the sub-field group and the number of sub-fields for one field are not limited to those of FIGS. 2A, 2B and 2C. Any luminance weight can be assigned to each of sub-fields constituting one field so long as they can reproduce the gray levels shown by input image data.

The following part explains a modification example which does not use some particular gray levels.

If a luminance weight of each of the sub-fields SF1 to SF12 is set as shown in FIGS. 2A, 2B and 2C, light emission is not performed in the sub-fields SF1 to SF5 when reproducing gray levels of multiples of 32, i.e., gray levels of 32, 64, 96, 128, 160, 192 and 224. In other words, light emission is performed in at least one of the sub-fields SF1 to SF5 when reproducing gray levels of other than multiples of 32.

This means that a write defect is more likely to occur in the sub-field group when reproducing gray levels of multiples of 32 than when reproducing gray levels of other than multiples of 32.

In view of this problem, in the conversion table shown in FIGS. 2A, 2B and 2C, the number of writing sub-fields L is set at a relatively large value of three for the gray levels 96, 128, 160 and 192.

The present modification example, on the other hand, does not use gray levels of multiples of 32. Which is to say, according to the present modification example, light emission is performed in at least one of the sub-fields SF1 to SF5 preceding the sub-field group.

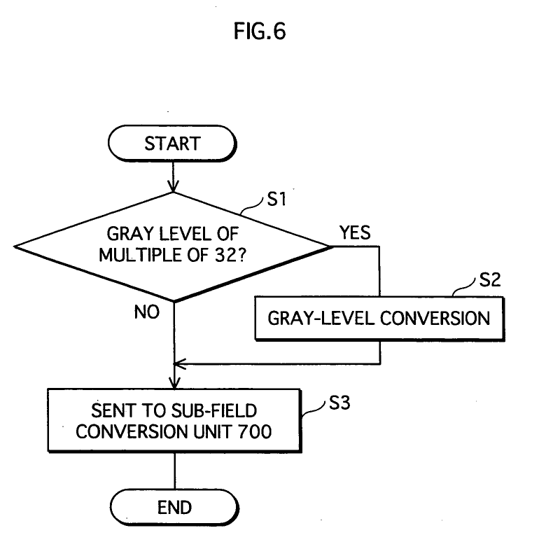

In the present modification example, the data detection unit 500 judges whether a gray level shown by input image data is a multiple of 32 or not as shown in FIG. 6 (step S1). If the judgment is affirmative, the data detection unit 500 performs a gray-level conversion operation to change the gray level of the input image data (step S2), then sends the input image data along with a new gray level to the sub-field conversion unit 700 (step S3).

The gray-level conversion operation in the step S2 is, for example, performed in the following manner. The gray level 32N (N=1, 2 . . . 7) may be converted, in time series, into a gray level (32N+1) or a gray level (32N−1). In addition, the gray level 32N may be converted into (32N+1) or (32N−1) by spatially distributing the difference (−1 or +1) between the original gray level and the new gray level using an error-diffusion dithering method or the like.

The gray level conversion in time series is, for example, performed in the following manner. Firstly, a series of fields in one second are numbered in order. Here, it is assumed that image data for a discharge cell of X-th row and Y-th column indicates a gray level of 32N (N is 1, 2 . . . 7). When the result of (X+Y) is an odd number, the gray level 32N is converted into a gray level (32N+1) for odd-numbered fields, and into a gray level (32N−1) for even-numbered fields. When the result of (X+Y) is an even number, the gray level 32N is converted into a gray level (32N−1) for odd-numbered fields, and into a gray level (32N+1) for even-numbered fields.

According to the above-mentioned modification example, light emission is performed in at least one of the sub-fields preceding the sub-field group when displaying an image in gray level. In other words, the present modification example does not employ gray levels for which a write defects is likely to occur (or for which the number of writing sub-fields L is set large), among full range gray levels shown in the conversion table presented in FIGS. 2A, 2B and 2C. As a result, the present modification example reduces the total number of writing sub-fields in one field with suppressing the occurrence of a write defect, when compared with the case where full range gray levels are used. In conclusion, power consumption of the data driver module can be reduced.

[Second Embodiment]

In a second embodiment, the number of writing sub-fields L for a given discharge cell is determined also based on the number of times the given discharge cell is illuminated in an immediately previous field.

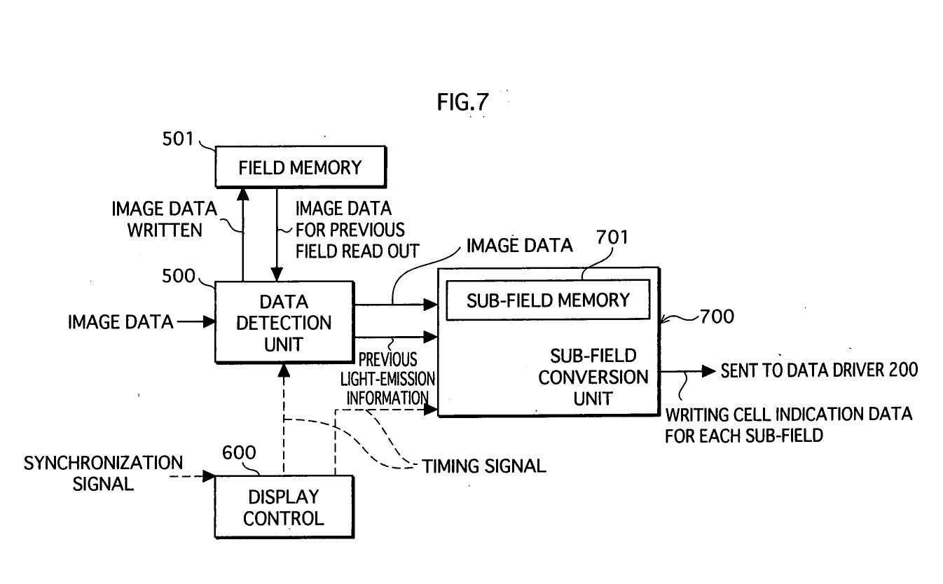

FIG. 7 shows a construction of part of a PDP device relating to the second embodiment.

The PDP device relating to the second embodiment and the PDP device relating to the first embodiment shown in FIG. 1 are the same in terms of their construction as a whole, but different from each other in terms of the functions of the data detection unit 500 and the sub-field conversion unit 700. Accordingly, FIG. 7 only shows the detection unit 500, the sub-field conversion unit 700 and the constituents around them.

As described in the first embodiment, the data detection unit 500 sends input image data for a given discharge cell to the sub-field conversion unit 700 in the second embodiment. According to the second embodiment, however, the detection unit 500 additionally detects the number of times at which a sustain discharge (light emission) is performed in the given discharge cell in an immediately previous field (hereinafter referred to as previous light-emission information). Then, the data detection unit 500 sends the previous light-emission information for the given discharge cell along with the image data to the sub-field conversion unit 700. The sub-field conversion unit 700 determines the number of writing sub-fields L for the given discharge cell with reference not only to the image data but also to the previous light-emission information.

The following part describes, in detail, the structures of the data detection unit 500 and the sub-field conversion unit 700 in the second embodiment.

Here, previous light-emission information represents the number of sustain pulses which cause light emission in an immediately previous field.

The data detection unit 500 includes a field memory 501, which is able to store image data for two fields.

The field memory 501 includes a first frame area and a second frame area. The detection unit 500 writes a gray level of a discharge cell into an address, in each of the first frame area and the second frame area, corresponding to the discharge cell in the PDP 100. Also, while the data detection unit 500 writes gray levels into one of the first frame area and the second frame area, it reads gray levels from the other.

The data detection unit 500 alternately writes/reads gray levels for one field into/from the first frame area and the second frame area. More specifically, when image data for a given discharge cell is input into the data detection unit 500, the data detection unit 500 overwrites a gray level written in an address corresponding to the given discharge cell in one of the first frame area and the second frame area into which the data detection unit 500 writes gray levels for the second last field. At the same time, the data detection unit 500 reads a gray level stored in an address corresponding to the given discharge cell in the other frame area (into which the data detection unit 500 writes gray levels for the last field).

Then, the data detection unit 500 obtains previous light-emission information for the given discharge cell based on the read gray level. Previous light-emission information is calculated, for instance, by multiplying the read gray level by three, if sustain pulses are applied in 3× speed mode (three sustain pulses for a gray level 1) in each sub-field.

The sub-field conversion unit 700 produces writing SF indication data with reference to image data and previous light-emission information sent from the data detection unit 500. Also, the sub-field conversion unit 700 produces writing cell indication data according to writing SF indication data as in the first embodiment, and sends writing cell indication data to the data driver 200.

The sub-field conversion unit 700 produces writing SF indication data based on image data and previous light emission information, by means of calculation or by referring to a conversion table. When referring to a conversion table, a plurality of conversion tables are beforehand prepared in correspondence to previous light-emission information. Then, one conversion table is selected from the conversion tables based on previous light-emission information, and the sub-field conversion unit 700 produces writing SF indication data by referring to the selected conversion table.

[Producing of Writing SF Indication Data by Calculation]

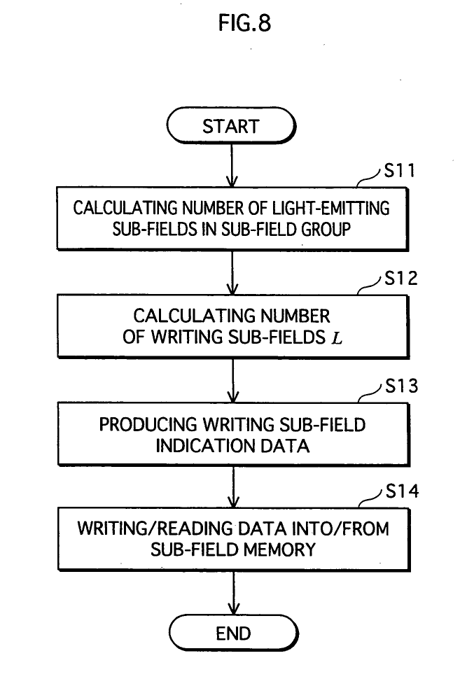

FIG. 8 is a flow chart showing, as an example, an operation of the sub-field conversion unit 700 relating to the second embodiment.

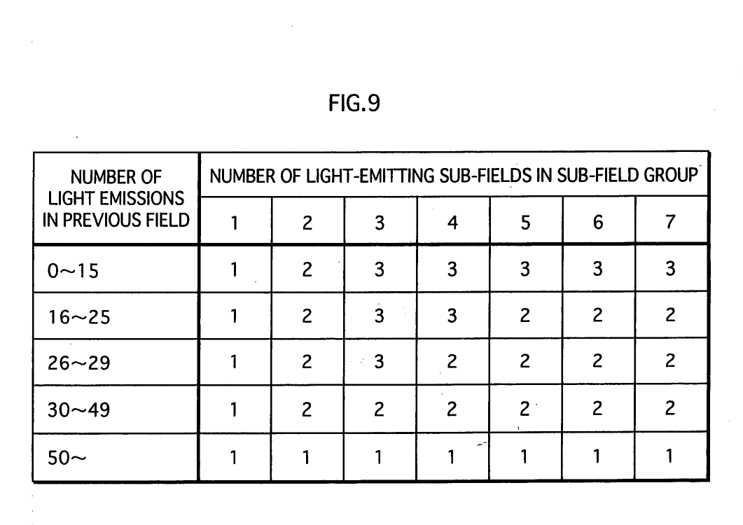

FIG. 9 shows, as an example, a calculation table used by the sub-field conversion unit 700 for calculating the number of writing sub-fields L based on image data and previous light-emission information sent from the data detection unit 500. The calculation table shows the number of writing sub-fields L, which is determined according to the number of light-emissions in an immediately previous field and the number of sub-fields in which light emission is performed (light-emitting sub-fields) in the sub-field group.

The operation performed by the sub-field conversion unit 700 is described with reference to FIG. 8 and FIG. 9.

The data detection unit 500 sends image data (a gray level) and previous light-emission information for a given discharge cell (the number of light emissions performed in an immediately previous field) to the sub-field conversion unit 700. Firstly, the sub-field conversion unit 700 calculates the number of light-emitting sub-fields in the sub-field group based on the image data. Since all the sub-fields in the sub-field group has a luminance weight of 32 in the second embodiment, the number of light-emitting sub-fields in the sub-field group is equal to the integer portion of the quotient of the gray level divided by 32 (step S11).

After this, the sub-field conversion unit 700 determines the number of writing sub-fields L according to the previous light-emission information and the number of light-emitting sub-fields in the sub-field group calculated in the step S11, by referring to the calculation table shown in FIG. 9 (step S12).

Next, the sub-field conversion unit 700 produces writing SF indication data based on the image data (the gray level), the number of light-emitting sub-fields in the sub-field group obtained in the step S11, and the number of writing sub-fields L obtained in the step S12.

Writing SF indication data is expressed by 12-bit data, and indicates sub-fields, among the sub-fields SF1 to SF12, in which a writing operation should be performed.

Such 12-bit writing SF indication data includes 5-bit data for the sub-fields SF1 to SF5 and 7-bit data for the sub-field group (the sub-fields SF6 to SF12). The 5-bit data is equal to a binary-coded remainder of the gray level divided by 32.

The 7-bit data is obtained based on the number of light-emitting sub-fields in the sub-field group calculated in the step S11 and the number of writing sub-fields L obtained in the step S12.

In detail, when the number of writing sub-fields L is one, a writing operation is performed only in a sub-field in which the first light emission is performed in the sub-field group, that is, in the sub-field SF(13—the number of light-emitting sub-fields in the sub-field group). When the number of writing sub-fields L is two, a writing operation is performed in the first light-emitting sub-field in the sub-field group, that is, the sub-field SF(13—the number of light-emitting sub-fields in the sub-field group) and the second light-emitting sub-field in the sub-field group, that is, the sub-field SF(14—the number of light-emitting sub-fields in the sub-field group). When the number of writing sub-fields L is three, a writing operation is performed in the first light-emitting sub-field SF(13—the number of light-emitting sub-fields in the sub-field group) to the second next sub-field SF (15—the number of light-emitting sub-fields in the sub-field group). (step S13)

The sub-field conversion unit 700 writes writing SF indication data into the sub-field memory 701, and at the same time, reads writing cell indication data from the sub-field memory 701 to send it to the data driver 200. (step S14)

[Description of the Above-Described Production Taking a Specific Gray Level as an Example]

The following part describes, in detail, how the data detection unit 500 and the sub-field conversion unit 700 produce writing SF indication data. Here, it is assumed that a gray level for a given discharge cell for a current field is 150 and a gray level for the given discharge cell for an immediately previous field is 15.

The data detection unit 500 calculates the number of light emissions in the immediately previous field (15×3=45). The data detection unit 500 sends image data (the gray level=150) and previous light-emission information (the number of light emissions=45) to the sub-field conversion unit 700.

The sub-field conversion unit 700 obtains the number of light-emitting sub-fields in the sub-field group, by calculating a quotient of 150 divided by 32. Here, the quotient is four and the remainder is 22. Accordingly, the number of light-emitting sub-fields in the sub-field group is four. After this, the sub-field conversion unit 700 obtains the number of writing sub-fields L, with reference to the calculation table in FIG. 9. Here, since the number of light emissions in the immediately previous field is 45 and the number of light-emitting sub-fields in the sub-field group is four, the number of writing sub-fields L is set at two.

Here, writing SF indication data includes 5-bit data for the sub-fields SF1 to SF5 and 7-bit data for the sub-fields SF6 to SF12. The 5-bit data is equal to the binary-coded remainder (22) obtained by the above division (01101). Since the number of light-emitting sub-fields in the sub-field group is four and the number of writing sub-fields L is two, the 7-bit data indicates that a writing operation is performed in the sub-fields SF9 and SF10 (0001100).

As a consequence, the 12-bit writing SF indication data for the given discharge cell is expressed by “011010001100”.

[Characteristics and Effects of the Calculation Table in FIG. 9]

The calculation table shown in FIG. 9 has the following characteristic (3).

(3) The calculation table shown in FIG. 9 is drawn up on the basis that a write defect is more likely to occur in the first writing sub-field in the sub-field group, when the number of light emissions in an immediately previous field is smaller. Therefore, in FIG. 9, if the number of light emissions in an immediately previous field is smaller, the number of writing sub-fields L is set larger.

According to the calculation table in FIG. 9, if the number of light emissions in an immediately previous field is 50 or more, the number of writing sub-fields L is set at one. If the number of light emissions in an immediately previous field is from 30 to 49, the number of writing sub-fields L is set at two or less. If the number of light emissions in an immediately previous field is 16 to 25, the number of writing sub-fields L is set at two or three. If the number of light emissions in an immediately previous field is 16 or less, except when the number of light-emitting sub-fields in the sub-field group is two or less, the number of writing sub-fields L is set at three.

In addition, the calculation table has the characteristic (1) explained in the first embodiment. In other words, when the time period from the start of the sub-field group to the first light-emitting sub-field in the sub-field group is longer, the number of writing sub-fields L is set larger.

A case where the number of light emissions in an immediately previous field is 16 to 25 is given as an example. If the number of light-emitting sub-fields in the sub-field group is 5 or more, a time period from the start of the sub-field group to the first light-emitting sub-field in the sub-field group is relatively small. Therefore, the number of writing sub-fields L is set at two. If the number of light-emitting sub-fields in the sub-field group is three or four, a time period from the start of the sub-field group to the first light-emitting sub-field in the sub-field group is relatively longer. Therefore, the number of writing sub-fields L is set at three.

As mentioned above, the number of writing sub-fields L is determined according to the calculation table having the characteristics (1) and (3). Accordingly, when a write defect is more likely to occur in the first light-emitting sub-field in the sub-field group, the number of writing sub-fields L is set larger (that is, a writing operation is performed in more sub-fields after the first light-emitting sub-field). As a consequence, when compared with the case in which the number of writing sub-fields L is uniformly determined, lighting defects in the sub-field group are reduced so as to suppress the occurrence of dark points with reducing the total number of writing sub-fields in one field.

Here, the power consumption of the data driver module is proportional to the total number of writing sub-fields. Therefore, if the total number of writing sub-fields is reduced as described above, the power consumption is also decreased.

Since the number of writing sub-fields L is determined using the calculation table shown in FIG. 9 as describe above, writing SF indication data can have the characteristics (1) and (3). In addition, writing SF indication data can have the characteristic (2) mentioned in the first embodiment (the number of writing sub-fields L is set large if the number of light emissions in the sub-fields SF1 to SF5 preceding a sub-field group is small) in the following manner.

The number of light emissions in the sub-fields SF1 to SF5 is obtained based on a gray level. Here, if the number of light emissions in the sub-fields SF1 to SF5 is greater than a specific number, one is subtracted from the number of writing sub-fields L obtained using the calculation table shown in FIG. 9.

The calculation table shown in FIG. 9 has the characteristics (1) and (3). Even when the table has only the characteristic (3), however, lighting defects in the sub-field group are suppressed with reducing the total number of writing sub-fields in one field.

[Production of Writing SF Indication Data by Referring to a Conversion Table Selected from a Plurality of Conversion Tables]

The sub-field conversion unit 700 may produce writing SF indication data by referring to a conversion table which is particularly drawn up based on the number of light emissions in an immediately previous field, instead of using calculation as in the above-mentioned steps S11 to S13.

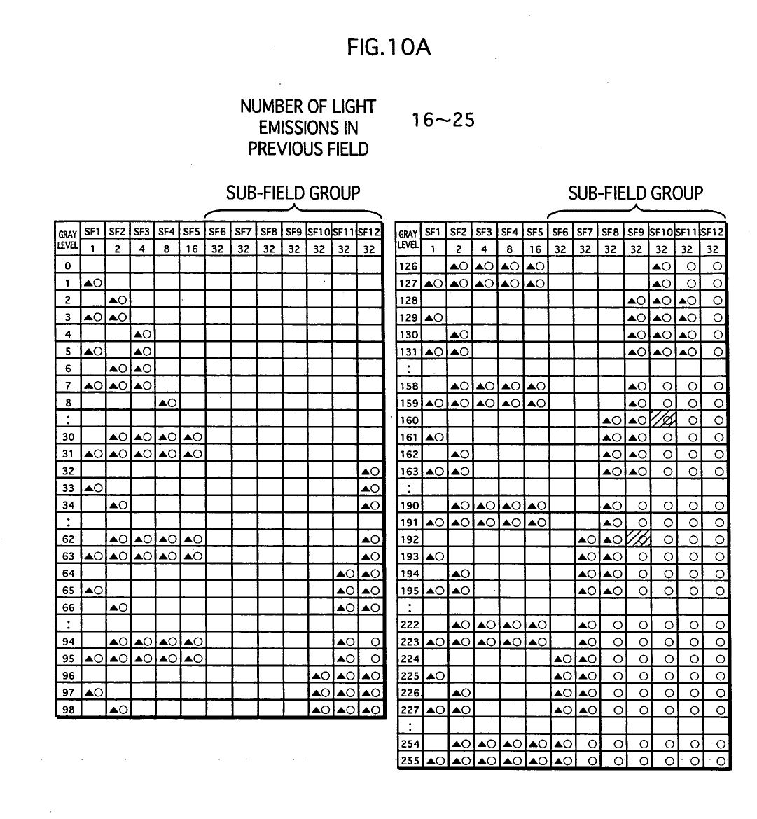

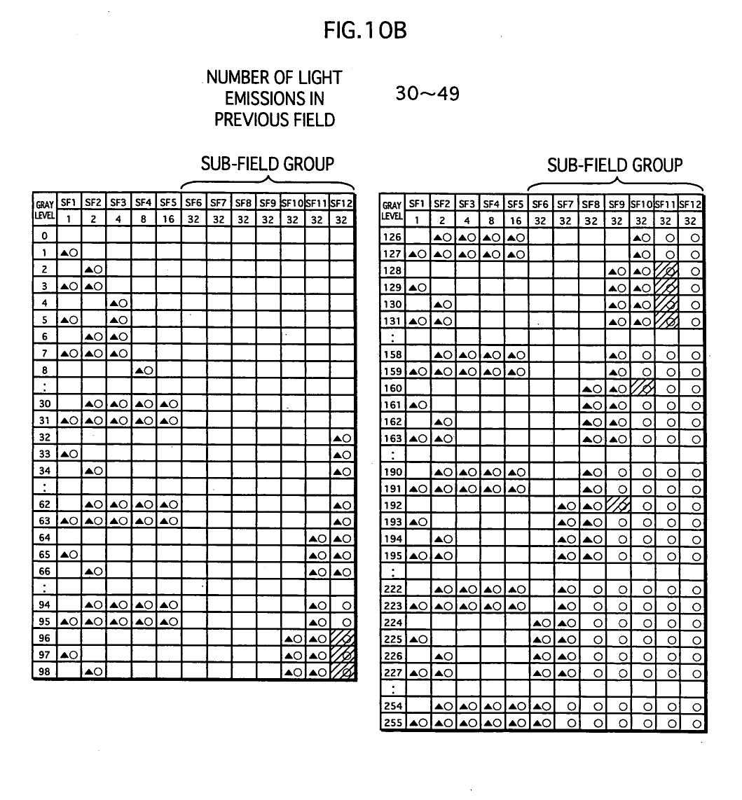

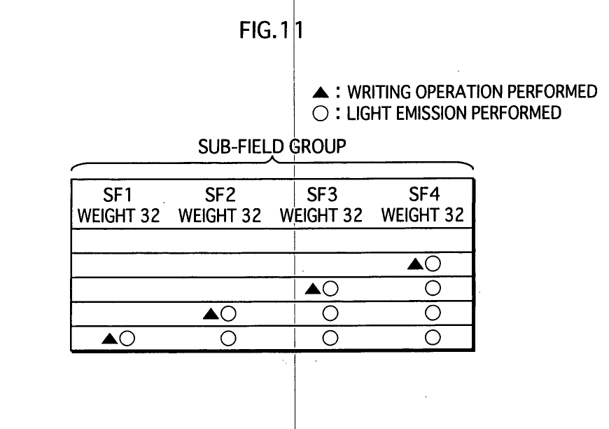

For example, if the number of light emissions in an immediately previous field is no more than 15, the sub-field conversion unit 700 refers to the conversion table used in the first embodiment and shown in FIGS. 2A, 2B and 2C to produce writing SF indication data corresponding to a gray level. If the number is from 16 to 25 and from 30 to 49, the sub-field conversion unit 700 refers to the conversion tables shown in FIG. 10A and FIG. 10B respectively. If the number is from 26 to 29 and no less than 50, the sub-field conversion unit 700 refers to different conversion tables (not shown).

The conversion tables shown in FIGS. 10A and 10B are the same as the conversion table shown in FIGS. 2A, 2B and 2C, except for shaded parts in FIGS. 10A and 10B. The shaded parts in FIGS. 10A and 10B indicate that a writing operation is not performed. Here, these conversion tables each have the characteristics (1) and (2), and the conversion table shown in FIG. 10B has more shaded parts than the conversion table in FIG. 10A. As a result, these conversion tables, at large, have the characteristic (3) (when the number of light emissions in an immediately previous field is larger, the number of writing sub-fields L is set smaller).

Accordingly, if writing SF indication data is produced by referring to appropriate one of these conversion tables which is selected depending on the number of light emissions in an immediately previous field, writing SF indication data can have the characteristics (1), (2) and (3).

[Modification Examples of the Second Embodiment]

The above rules (1), (2) and (3) are preferably followed when producing writing SF indication data for gray levels 64 to 255, that is, if light emission is performed in two or more sub-fields in the sub-field group to reproduce a gray level, but may be followed for part of those gray levels.

Luminance weights for the sub-fields forming a the sub-field group are uniformly 32 in the second embodiment, as shown in FIGS. 2A, 2B and 2C, but not necessarily set at a uniform value.

In addition, luminance weights for the sub-fields preceding the sub-field group and the number of sub-fields for one field are not limited to those shown in FIGS. 2A, 2B and 2C. Any luminance weight can be assigned to each of the sub-fields constituting one field so long as they can reproduce gray levels of input image data.

According to the present modification example, if a gray level shown by input image data is a multiple of 32, a gray-level conversion operation is performed before the image data is written into the field memory 501, as mentioned in the modification example of the first embodiment. This means that gray levels of multiples of 32 are not used and light emission is always performed in at least one of the sub-fields SF1 to SF5 preceding the sub-field group. This reduces power consumption of the data driver module with suppressing the occurrence of a write defect, when compared with the case in which full range gray levels are used.

[A Driving Method Whereby a Termination Writing Operation is Performed in a Sub-Field Group]

According to the driving methods described in the first and second embodiments, if a writing operation is performed in one sub-field in the sub-field group, light emission is performed in that sub-field in the sub-field group and continued in all of the succeeding sub-field in the sub-field group. However, there is a driving method opposite to such. According to such a driving method, all of the discharge cells are made active (i.e. in a state where a discharge starts in the discharge cells when a sustain pulse is applied) at the start of a sub-field group, and light emission is terminated when the first writing operation is performed in the sub-field group. Which is to say, light emission is maintained until immediately before the first writing sub-field in the sub-field group.

When using this driving method whereby a termination writing operation is performed, the state of discharge cells immediately before the start of a sub-field group seemingly, more or less, have an influence on the outcome of a termination writing operation, only a slight influence though.

Accordingly, when using a driving method whereby a termination writing operation is performed, the number of writing sub-fields L may be also determined based on the number of light emissions in sub-fields preceding a sub-field group and the number of light emissions in an immediately previous field. This can reduce lighting defects in a sub-field group with it being possible to reduce the total number of writing sub-fields in one field.

### INDUSTRIAL APPLICABILITY

An image display device and a driving method thereof according to the present invention are applicable to a display device used for computers, televisions and the like.

1. A method of driving an image display device in which a plurality of cells are arranged, to display an image in gray level, comprising:
a writing sub-field selecting step of selecting, for each of the plurality of cells, one or more sub-fields in which a writing operation is to be performed, from N sub-fields which form one field and each have a luminance weight, based on an input image signal for the cell;
a writing step of performing the writing operation to the cell in each of the sub-fields selected in the writing sub-field selecting step; and
a light emission step of performing light emission in the cell to which the writing operation is performed in the writing step, wherein
if the writing operation and the light emission are performed in the cell in any sub-field in a sub-field group which is constituted by M consecutive sub-fields in the N sub-fields, where 2□M□N, the light emission is sustained in the cell throughout all succeeding sub-fields in the sub-field group, and
when the writing operation is performed in at least one sub-field in the sub-field group, and L is a number showing how many sub-fields in the sub-field group have been selected in the writing sub-field selecting step, L is determined based on at least one of the input image signal for the cell for the field and an input image signal for the cell for an immediately previous field.

2. The method of claim 1, wherein
the more difficult the cell is expected to be to illuminate, judging from at least one of the input image signal for the cell for the field and the input image signal for the cell for the immediately previous field, the larger L is set.

3. The method of claim 1, wherein
the longer a time period from a start of the sub-field group to a sub-field in which the writing operation is to be first performed in the sub-field group is, the larger L is set.

4. The method of claim 1, wherein
one or more sub-fields precede the sub-field group in the field, and
the smaller a degree of the light emission in the cell in the sub-fields preceding the sub-field group is, the larger L is set.

5. The method of claim 4, wherein
the smaller a number of times the cell is illuminated in the sub-fields preceding the sub-field group is, the larger L is set.

6. The method of claim 1, wherein
the smaller a degree of the light emission in the cell in the immediately previous field is, the larger L is set.

7. The method of claim 6, wherein
the smaller a number of times the cell is illuminated in the immediately previous field is, the larger L is set.

8. The method of claim 1, wherein
in the writing sub-field selecting step,
L is determined based on at least one of the input image signal for the cell for the field and the input image signal for the cell for the immediately previous field, and
a sub-field in the sub-field group in which the writing operation is to be performed is selected based on L.

9. The method of claim 1, wherein
one or more sub-fields precede the sub-field group in the field, the method further comprising
a gray-level converting step of, if the writing operation is performed in the cell only in the sub-field group to reproduce a gray level shown by the input image signal for the cell for the field, converting the gray level into a gray level for which the writing operation is to be performed also in at least one of the sub-fields preceding the sub-field group, prior to the writing sub-field selecting step.

10. A method of driving an image display device in which a plurality of cells are arranged, to display an image in gray level, comprising:
a writing sub-field selecting step of selecting, for each of the plurality of cells, one or more sub-fields in which a writing operation is to be performed, from N sub-fields which form one field and each have a luminance weight, based on an input image signal for the cell;
a writing step of performing the writing operation to the cell in each of the sub-fields selected in the writing sub-field selecting step; and
a light emission step of performing light emission in the cell to which the writing operation is performed in the writing step, wherein
if the writing operation and the light emission are performed in the cell in any sub-field in a sub-field group which is constituted by M consecutive sub-fields in the N sub-fields, where 2□M□N, the light emission is sustained in the cell throughout all succeeding sub-fields in the sub-field group,
one or more sub-fields precede the sub-field group in the field, and
out of gray levels for which the light emission is performed in the cell in the sub-field group, a gray level for which the light emission is performed in the cell also in at least one of the sub-fields preceding the sub-field group is employed to display the image in gray level.

11. An image display device including an image display unit in which a plurality of cells are arranged and a driving unit which displays an image in gray level, the driving unit comprising:
a writing sub-field selecting unit operable to select, for each of the plurality of cells, one or more sub-fields in which a writing operation is to be performed, from N sub-fields which form one field and each have a luminance weight, based on an input image signal for the cell;
a writing unit operable to perform the writing operation to the cell in each of the sub-fields selected by the writing sub-field selecting unit; and
a light emission unit operable to perform light emission in the cell to which the writing operation is performed by the writing unit, wherein
if the writing operation and the light emission are performed in the cell in any sub-field in a sub-field group which is constituted by M consecutive sub-fields in the N sub-fields, where 2□M□N, the light emission is sustained in the cell throughout all succeeding sub-fields in the sub-field group, and
when L is a number showing how many sub-fields in the sub-field group have been selected by the writing sub-field selecting unit, L is determined based on at least one of the input image signal for the cell for the field and an input image signal for the cell for an immediately previous field.

12. The image display device of claim 11, wherein
the more difficult the cell is expected to be to illuminate, judging from at least one of the input image signal for the cell for the field and the input image signal for the cell for the immediately previous field, the larger L is set.

13. The image display device of claim 11, wherein
the longer a time period from a start of the sub-field group to a sub-field in which the writing operation is to be first performed in the sub-field group is, the larger L is set.

14. The image display device of claim 11, wherein
one or more sub-fields precede the sub-field group in the field, and
the smaller a degree of the light emission in the cell in the sub-fields preceding the sub-field group is, the larger L is set.

15. The image display device of claim 14, wherein
the smaller a number of times the cell is illuminated in the sub-fields preceding the sub-field group is, the larger L is set.

16. The image display device of claim 11, wherein
the smaller a degree of the light emission in the cell in the immediately previous field is, the larger L is set.

17. The image display device of claim 16, wherein
the smaller a number of times the cell is illuminated in the immediately previous field is, the larger L is set.

18. The image display device of claim 11, wherein
the writing sub-field selecting unit
determines L based on at least one of the input image signal for the cell for the field and the input image signal for the cell for the immediately previous field, and
selects a sub-field in the sub-field group in which the writing operation is to be performed based on L.

19. The image display device of claim 11, wherein
one or more sub-fields precede the sub-field group in the field, the image display device further comprising
a gray-level converting unit operable to, if the writing operation is performed in the cell only in the sub-field group to reproduce a gray level shown by the input image signal for the cell for the field, convert the gray level into a gray level for which the writing operation is to be performed also in at least one of the sub-fields preceding the sub-field group before the writing sub-field selecting unit selects the sub-fields.

20. An image display device including an image display unit in which a plurality of cells are arranged and a driving unit which displays an image in gray level, the driving unit comprising:
a writing sub-field selecting unit operable to select, for each of the plurality of cells, one or more sub-fields in which a writing operation is to be performed, from N sub-fields which form one field and each have a luminance weight, based on an input image signal for the cell;
a writing unit operable to perform the writing operation to the cell in each of the sub-fields selected by the writing sub-field selecting unit; and
a light emission unit operable to perform light emission in the cell to which the writing operation is performed by the writing unit, wherein if the writing operation and the light emission are performed in the cell in any sub-field in a sub-field group which is constituted by M consecutive sub-fields in the N sub-fields, where 2□M□N, the light emission is sustained in the cell throughout all succeeding sub-fields in the sub-field group,
one or more sub-fields precede the sub-field group in the field, and
out of gray levels for which the light emission is performed in the cell in the sub-field group, a gray level for which the light emission is performed in the cell also in at least one of the sub-fields preceding the sub-field group is employed to display the image in gray level.
